(19) United States
(12) Patent Application Publication
(10) Pub. No.: US 2025/0202679 A1
(43) Pub. Date: Jun. 19, 2025

(54) INFERENCING ON HOMOMORPHICALLY ENCRYPTED VECTORS AT TRANSFORMER

(71) Applicant: Microsoft Technology Licensing, LLC, Redmond, WA (US)

(72) Inventors: Shaohan HUANG, Beijing (CN); Li DONG, Beijing (CN); Shuming MA, Beijing (CN); Furu WEI, Beijing (CN)

(73) Assignee: Microsoft Technology Licensing, LLC, Redmond, WA (US)

(21) Appl. No.: 18/843,060

(22) PCT Filed: Mar. 30, 2022
(86) PCT No.: PCT/CN2022/084134

§ 371 Date: Aug. 30, 2024

(51) Int. Cl. H04L 9/00

(52) U.S. Cl. CPC H04L 9/008

(57) ABSTRACT

A server computing device is provided, including a processor configured to receive a homomorphically encrypted input embedding vector from a client computing device. At a transformer network, the processor may generate a plurality of homomorphically encrypted intermediate vectors at least in part by performing inferencing on the homomorphically encrypted input embedding vector. The processor may transmit the plurality of homomorphically encrypted intermediate output vectors to the client computing device. The processor may receive a plurality of homomorphically encrypted intermediate input vectors from the client computing device subsequently to transmitting the homomorphically encrypted intermediate output vectors to the client computing device. At the transformer network, the processor may generate a homomorphically encrypted output vector at least in part by performing additional inferencing on the homomorphically encrypted intermediate input vectors. The processor may transmit the homomorphically encrypted output vector to the client computing device.

### BACKGROUND

Transformer networks are a class of neural networks that have recently been applied to a wide variety of tasks such as machine translation, text summarization, sentiment analysis, creative writing, programming assistance, and computer vision. Inferencing using transformer networks is frequently performed server-side as a cloud computing service on input data received from a client device. By performing inferencing as a cloud computing service, the provider of the inferencing service may retain a proprietary transformer model. In addition, since transformer inferencing is often highly processing- and memory-intensive, inferencing at the cloud may allow the transformer network to be used with inputs received from a wider range of computing devices.

### SUMMARY

According to one aspect of the present disclosure, a server computing device is provided, including a processor configured to receive a homomorphically encrypted input embedding vector from a client computing device. At a transformer network, the processor may be further configured to generate a plurality of homomorphically encrypted intermediate vectors at least in part by performing inferencing on the homomorphically encrypted input embedding vector. The processor may be further configured to transmit the plurality of homomorphically encrypted intermediate output vectors to the client computing device. The processor may be further configured to receive a plurality of homomorphically encrypted intermediate input vectors from the client computing device subsequently to transmitting the homomorphically encrypted intermediate output vectors to the client computing device. At the transformer network, the processor may be further configured to generate a homomorphically encrypted output vector at least in part by performing additional inferencing on the homomorphically encrypted intermediate input vectors. The processor may be further configured to transmit the homomorphically encrypted output vector to the client computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a server computing device and a client computing device at which a transformer network and a homomorphic encryption module may be executed, respectively, according to one example embodiment.

FIG. 2 schematically shows the server computing device in additional detail when the transformer network is instantiated at a processor, according to the example of FIG. 1.

FIG. 3 schematically shows the architecture of the transformer network in additional detail, according to the example of FIG. 1.

FIG. 4 schematically shows encoder multi-head attention included in an encoder layer of the transformer network, according to the example of FIG. 3.

FIG. 5 schematically shows an estimated softmax function that may be computed during inferencing at the transformer network, according to the example of FIG. 1.

FIG. 6A schematically shows portions of the encoder layer following the encoder multi-head attention, according to the example of FIG. 4.

FIG. 6B schematically shows portions of a decoder layer following the decoder multi-head attention, according to the example of FIG. 3.

FIG. 7 shows pseudocode of a transformer training algorithm that may be performed when training the transformer network, according to the example of FIG. 1.

FIG. 8 schematically shows a softmax estimation machine learning algorithm during training, according to the example of FIG. 5.

FIG. 9 shows pseudocode of a transformer runtime algorithm, according to the example of FIG. 1.

FIG. 10A shows a flowchart of a method by which homomorphically encrypted inferencing may be performed at a transformer network, according to the example of FIG. 1.

FIG. 10B shows further steps of the method of FIG. 10A that may be performed at a client computing device when a plurality of homomorphically encrypted rectified linear unit (ReLU) input vectors are received from the server computing device.

FIG. 10C shows further steps of the method of FIGS. 10A-10B that may be performed subsequently to the client computing device transmitting a plurality of homomorphically encrypted intermediate input vectors to the server computing device.

FIG. 11 shows additional steps of the method of FIGS. 10A-10C that may be performed in some examples when computing an estimated softmax function.

FIG. 12 shows additional steps of the method of FIGS. 10A-10C that may be performed at each of a plurality of feed-forward networks included in the transformer network.

FIG. 13 shows additional steps of the method of FIGS. 10A-10C that may be performed subsequently to performing inferencing at a plurality of decoder layers of the transformer network.

FIG. 14 shows a schematic view of an example computing environment in which the server computing device and the client computing device of FIG. 1 may be instantiated.

### DETAILED DESCRIPTION

When cloud-based inferencing is performed at a transformer network as discussed above, user inputs are typically entered into the transformer network in unencrypted form. Accordingly, the user inputs or input embedding vectors may be vulnerable to interception by malicious parties. This lack of encryption may make existing transformer networks unsuitable for use in areas such as medicine, banking, or law, where data confidentiality is important to users. Existing encryption methods also present challenges when applied to transformer inputs and outputs, since such encryption methods would convert the input data into forms in which the input data may not be processed to produce meaningful outputs at a conventional transformer network.

In order to address the above challenges, the inventors have developed techniques by which homomorphic encryption may be applied to data processed at a transformer network. Homomorphic encryption is a type of encryption in which specific computations may be performed on ciphertext while the ciphertext remains encrypted. When ciphertext encrypted using homomorphic encryption is decrypted, the resulting plaintext output matches an output that would be obtained by performing the same computation on unencrypted input data. Homomorphic encryption may be described by the equation

F(x)=D(g(E(x))

where x is a plaintext input, F is a function performed on the plaintext input, E is an encryption function, D is a decryption function, and g is a constructed function that performs an analogue of the computation F on the encrypted input data E(x).

Existing forms of homomorphic encryption support only a subset of functions rather than allowing arbitrary computation to be performed on the ciphertext. One challenge when applying homomorphic encryption to transformer inputs is that conventional transformer network architectures include functions that are not supported by currently available methods of homomorphic encryption. Accordingly, as discussed in further detail below, the devices and methods provided herein may approximate unsupported operations with other functions. In addition, the server may offload some operations to the client. By using function substitutions and offloading, the server may perform inferencing on encrypted data at a transformer network without the server having to process unencrypted user input. The privacy of the user's data may thereby be protected when performing inferencing at a transformer network in a cloud computing environment.

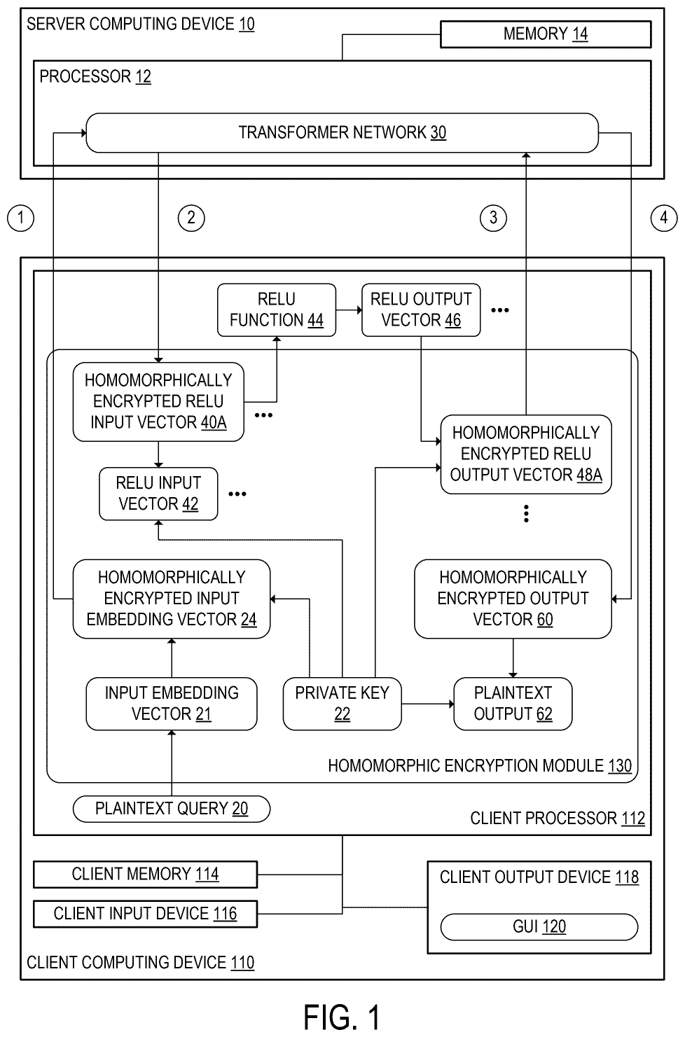

FIG. 1 schematically shows a server computing device 10 and a client computing device 110, according to one example embodiment. The server computing device 10, as shown in the example of FIG. 1, may include a processor 12 that is communicatively coupled to memory 14. The components of the server computing device 10 may, in some examples, be distributed between a plurality of physical computing devices that are configured to communicate over a network. For example, a plurality of physical computing devices located in a data center and configured to communicate over an internal data center network may instantiate the server computing device 10 as a virtual server computing device.

The server computing device 10 may be configured to receive data from and transmit data to the client computing device 110. For example, the server computing device 10 may be configured to communicate with the client computing device 110 over a network. The client computing device 110 may include a client device processor 112 that is communicatively coupled to client device memory 114. The client computing device may further include one or more client input devices 116 and one or more client output devices 118. In some examples, the client computing device 110 may be configured to present a graphical user interface (GUI) 120 to the user via a display included among the one or more client output devices 118. The user may, in such examples, interact with the GUI 120 using the one or more client input devices 116 to provide user input to the client computing device 110.

FIG. 1 shows the client computing device 110 when the client device processor 112 executes a homomorphic encryption module 130. The homomorphic encryption module 130 may be configured to communicate with a transformer network 30 by transmitting homomorphically encrypted data to, and receiving homomorphically encrypted data from, the server computing device 10. At the homomorphic encryption module 130, the client device processor 112 may be configured to receive a plaintext query 20. For example, the plaintext query 20 may be input at the GUI 120 by the user of the client computing device 110. The plaintext query 20 may be a text input. Additionally or alternatively, the plaintext query 20 may include one or more other types of input data such as image data or audio data. The word “plaintext” does not limit the plaintext query 20 to a text format.

The client device processor 112 may be further configured to generate an input embedding vector 21 from the plaintext query 20. The input embedding vector 21 may represent the plaintext query 20 in vector form. The client device processor 112 may be further configured to homomorphically encrypt the input embedding vector 21 to generate a homomorphically encrypted embedding vector 24. The input embedding vector 21 may be homomorphically encrypted using a private key 22 of the client computing device 110. The homomorphically encrypted embedding vector 24 may be generated using a homomorphic encryption algorithm that supports both addition and multiplication operations on encrypted data. For example, the client device processor 112 may be configured to generate the homomorphically encrypted embedding vector 24 using a CKKS algorithm, a GSW algorithm, a FHEW algorithm, a TFHE algorithm, a BGV algorithm, a BFV algorithm, or some other homomorphic encryption algorithm. Subsequently to generating the homomorphically encrypted embedding vector 24, the client device processor 112 may be further configured to transmit the homomorphically encrypted input embedding vector 24 to the server computing device 10, as shown at step 1 in the example of FIG. 1.

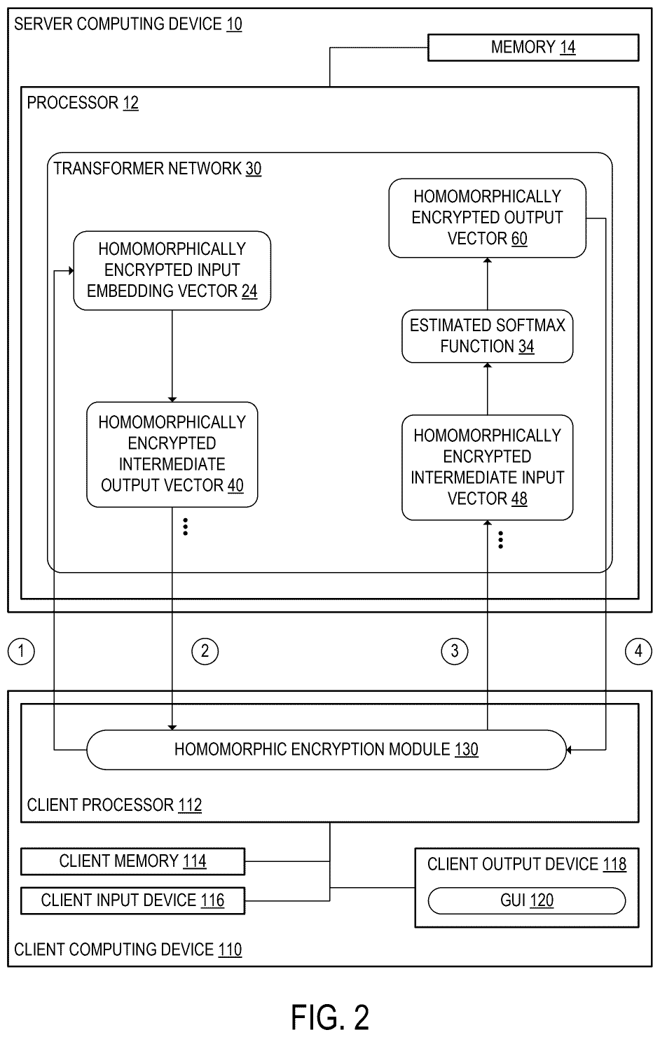

FIG. 2 schematically shows the server computing device 10 in additional detail when a transformer network 30 is instantiated at the processor 12. The processor 12 of the server computing device 10 may be configured to receive the homomorphically encrypted input embedding vector 24 from the client computing device 110. At the transformer network 30, the processor 12 may be further configured to generate a plurality of homomorphically encrypted intermediate output vectors 40 at least in part by performing inferencing on the homomorphically encrypted input embedding vector 24. The homomorphically encrypted intermediate output vectors 40 may be vectors of intermediate processing results generated by performing addition and multiplication operations on the homomorphically encrypted embedding vector 24.

The processor 12 may be further configured to transmit the plurality of homomorphically encrypted intermediate output vectors 40 to the client computing device 110, as shown at step 2 in the example of FIG. 2. Thus, the processor 12 may be configured to offload some operations to the client computing device 110 when those operations are not supported by the homomorphic encryption algorithm used to encrypt the input embedding vector 21 at the homomorphic encryption module 130. Subsequently to transmitting the homomorphically encrypted intermediate output vectors 40 to the client computing device 110, the processor 12 may be further configured to receive a plurality of homomorphically encrypted intermediate input vectors 48 from the client computing device 110. The homomorphically encrypted intermediate input vectors 48 may be homomorphically encrypted vectors that are computed by performing the offloaded operations on the homomorphically encrypted intermediate output vectors 40 at the client device processor 112.

Returning to FIG. 1, in some examples, the processor 12 may be configured to offload computation of a rectified linear unit (ReLU) function 44 to the client computing device 110. The ReLU function 44 is the function given by:

$$ReLU ( x ) = \{ \begin{matrix}0 , & x < 0 \\ x , & x \geq 0\end{matrix}$$

Since the ReLU function 44 is not an addition or multiplication operation, the ReLU function may not be supported by the homomorphic encryption algorithm with which the homomorphically encrypted input embedding vector 24 was generated. Thus, the plurality of homomorphically encrypted intermediate output vectors 40 may include a plurality of homomorphically encrypted ReLU input vectors 40A. The client device processor 112 may be configured to receive the plurality of homomorphically encrypted rectified linear unit (ReLU) input vectors 40A from the server computing device 10 subsequently to transmitting the homomorphically encrypted input embedding vector 24 to the server computing device 10. At the homomorphic encryption module 130, the client device processor 112 may be further configured to decrypt the plurality of homomorphically encrypted ReLU input vectors 40A using the private key 22 to generate a plurality of ReLU input vectors 42. The client device processor 112 may be further configured to apply the ReLU function 44 to each of the plurality of ReLU input vectors 42 to generate a corresponding plurality of ReLU output vectors 46. In addition, the client device processor 112 may be further configured to homomorphically encrypt the plurality of ReLU output vectors 46 with the private key 22 to generate a respective plurality of homomorphically encrypted ReLU output vectors 48A. As shown at step 3, the client device processor 112 may be further configured to transmit the plurality of homomorphically encrypted ReLU output vectors 48A to the server computing device 10. Thus, the homomorphically encrypted ReLU output vectors 48A may be received at the server computing device 10 as the homomorphically encrypted intermediate input vectors 48.

As shown in FIG. 2, the processor 12 of the server computing device 10 may be further configured to generate a homomorphically encrypted output vector 60 at the transformer network 30 at least in part by performing additional inferencing on the homomorphically encrypted intermediate input vectors 48. The homomorphically encrypted output vector 60 may be a final result of the inferencing performed at the transformer network 30. In some examples, as discussed in further detail below, the processor 12 may be configured to perform multiple iterations of outputting a plurality of homomorphically encrypted intermediate output vectors 40 and receiving a plurality of homomorphically encrypted intermediate input vectors 48 when generating the homomorphically encrypted output vector 60. Accordingly, the processor 12 may be configured to offload multiple functions to the client computing device 110. The processor 12 may be further configured to transmit the homomorphically encrypted output vector 60 to the client computing device 110, as shown at step 4.

As depicted in FIG. 2, the client device processor 112 may be further configured to receive the homomorphically encrypted output vector 60 from the server computing device 10 subsequently to transmitting the plurality of homomorphically encrypted ReLU output vectors 48A to the server computing device 10. The client device processor 112 may be further configured to compute a plaintext output 62 at least by decrypting the homomorphically encrypted output vector 60. Subsequently to computing the plaintext output 62, the client device processor 112 may be further configured to output the plaintext output 62 to an additional computing process. For example, the client device processor 112 may be configured to output the plaintext output 62 for display at the GUI 120.

In the example of FIG. 2, each computation performed on the homomorphically encrypted input embedding vector 24 and the homomorphically encrypted intermediate input vectors 48 during inferencing at the transformer network 30 may be an addition or multiplication operation. Thus, the processor 12 may be configured to perform operations on the homomorphically encrypted input embedding vector 24 and the homomorphically encrypted intermediate input vectors 48 that are supported by the homomorphic encryption technique utilized at the homomorphic encryption module 130. Inferencing may accordingly be performed at the server computing device 10 without the processor 12 having to decrypt the encrypted vectors.

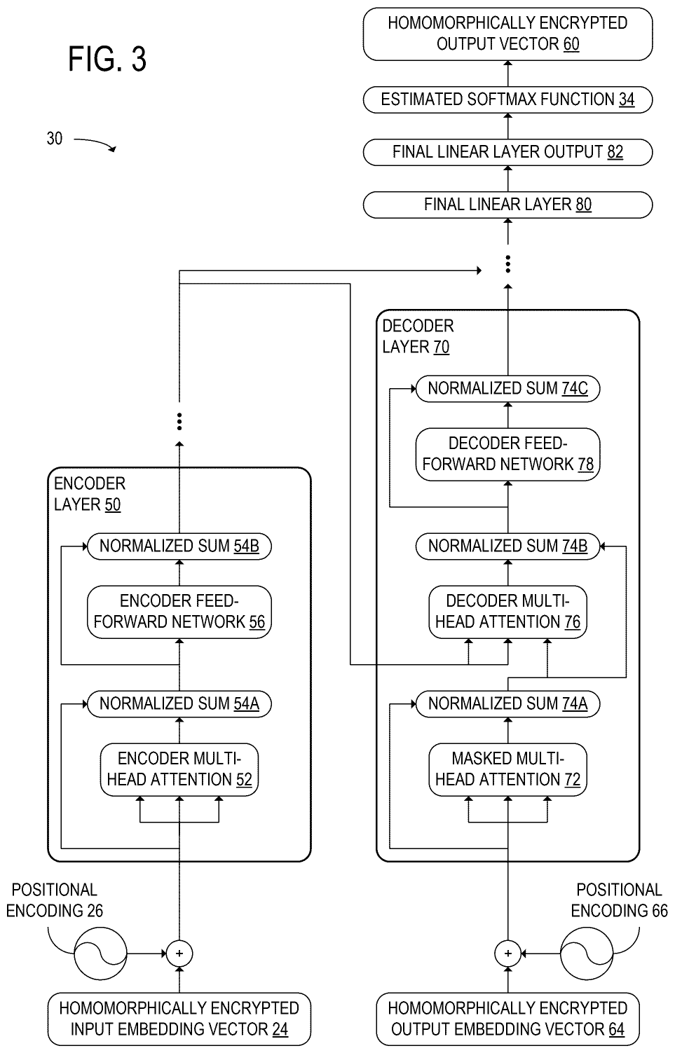

FIG. 3 schematically shows the architecture of the transformer network 30 in additional detail, according to one example. The transformer network 30 may include a plurality of encoder layers 50 and a plurality of decoder layers 70. As shown in the example of FIG. 3, each encoder layer 50 may include an encoder multi-head attention 52 and an encoder feed-forward network 56. Each decoder layer 70 may include a masked multi-head attention 72, a decoder multi-head attention 76, and a decoder feed-forward network 78.

When the transformer network 30 receives the homomorphically encrypted input embedding vector 24, the processor 12 may be configured to compute a positional encoding 26 of the homomorphically encrypted input embedding vector 24. For example, the positional encoding 26 may be a trigonometric-function positional encoding. The positional encoding 26 may indicate positions of input tokens included in the homomorphically encrypted embedding vector 24.

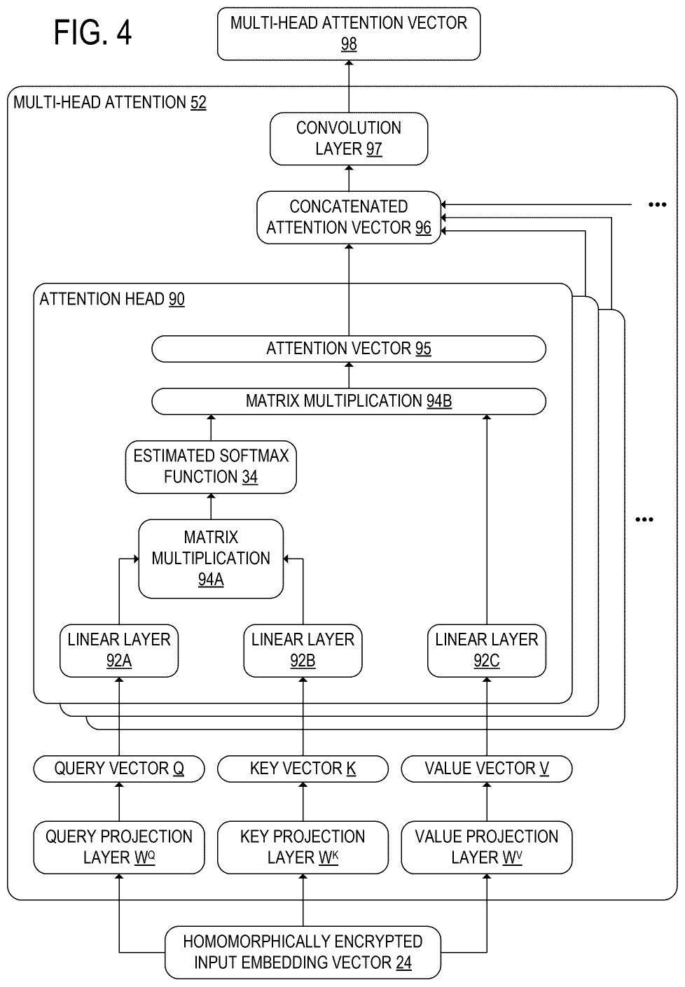

The processor 12 may be further configured to input the homomorphically encrypted input embedding vector 24 and the positional encoding 26 into an encoder layer 50. At the encoder layer 50, the processor 12 may be configured to perform encoder multi-head attention 52 on the homomorphically encrypted input embedding vector 24 and the positional encoding 26. FIG. 4 schematically shows the encoder multi-head attention 52 of the encoder layer 50 in additional detail. As depicted in FIG. 4, at the encoder multi-head attention 52, the processor 12 may be configured to compute a query vector Q, a key vector K, and a value vector V as input. The query vector Q and the key vector K may both have a dimension dₖ, and the value vector V may have a dimension dᵥ. The query vector Q, the key vector K, and the value vector V may be computed by multiplying the homomorphically encrypted input embedding vector 24 by a query projection layer W^{Q}, a key projection layer W^{K}, and a value projection layer W^{V}, respectively. The projection layers W^{Q}, W^{K}, and W^{V} may include matrix elements that are parameters of the transformer network 30. The parameters included in the projection layers W^{Q}, W^{K}, and W^{V} may be learned during a training phase, as discussed in further detail below.

Subsequently to generating the query vector Q, the key vector K, and the value vector V, the processor 12 may be further configured to input the query vector Q, the key vector K, and the value vector V into a plurality of attention heads 90. Each of the attention heads 90 may include a respective linear layer 92A, linear layer 92B, and linear layer 92C. The linear layer 92A may be configured to receive the query vector Q, the linear layer 92B may be configured to receive the key vector K, and the linear layer 92C may be configured to receive the value vector V. The linear layers 92A, 92B, and 92C may each include a plurality of respective weights, and the weights of the linear layers 92A, 92B, and 92C may differ between the plurality of attention heads 90.

At each attention head 90, the processor 12 may be further configured to compute a matrix multiplication 94A of the output of the linear layer 92A with the output of the linear layer 92B. The matrix multiplication 94A may be an elementwise multiplication. In addition, the processor 12 may be configured to divide each of the elements of the result of the matrix multiplication 94A by \sqrt{dₖ}. In some examples, at each of the plurality of attention heads 90 included in the transformer network 30, the processor 12 may be configured to perform attention score scaling by 1/\sqrt{dₖ} at the respective query projection layer W^{Q} of that attention head 90. The processor 12 may be further configured to compute an estimated softmax function 34 on the output of the matrix multiplication 94A and perform an additional matrix multiplication 94B of the result of the estimated softmax function 34 by the value vector V to compute an attention vector 95. Accordingly, the attention vector 95 may be expressed as

$$softmax ( \frac{{QK}^{T}}{\sqrt{{d}_{k}}} ) V$$

In the above expression, the attention vector 95 is a scaled dot-product attention matrix multiplied by the value vector V.

At the encoder multi-head attention 52, downstream of the plurality of attention heads 90, the processor 12 may be further configured to concatenate the plurality of attention vectors 95 computed at the plurality of attention heads 90 to compute a concatenated attention vector 96. The processor 12 may be further configured to input the concatenated attention vector 96 into a convolution layer 97. At the convolution layer 97, the processor 12 may be further configured to compute a multi-head attention vector 98 for the homomorphically encrypted input embedding vector 24 based at least in part on the concatenated attention vector 96. The convolution layer 97 may have a plurality of parameters that are learned during the training phase.

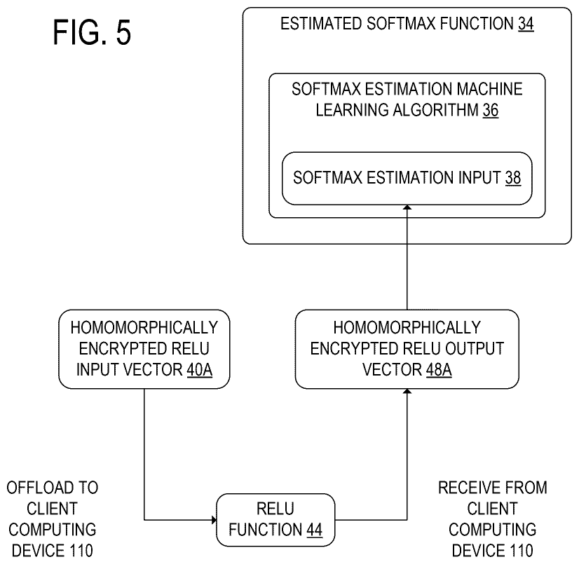

As discussed above, the processor 12 may be configured to compute an estimated softmax function 34 at each of the plurality of attention heads 90. The computation of the estimated softmax function 34 is schematically depicted in FIG. 5, according to one example. Computing the estimated softmax function 34 may include offloading computation of a ReLU function 44 to the client computing device 110. As shown in the example of FIG. 5, when computing the estimated softmax function 34, the processor 12 may be configured to transmit a homomorphically encrypted ReLU input vector 40A to the client computing device 110 as a homomorphically encrypted intermediate output vector 40. The ReLU function 44 may be computed at the client device processor 112 as discussed above with reference to FIG. 1. The processor 12 may be further configured to receive a homomorphically encrypted ReLU output vector 48A from the client computing device 110 as a homomorphically encrypted intermediate input vector 48 subsequently to transmitting the homomorphically encrypted ReLU input vector 40A to the client computing device 110.

As depicted in the example of FIG. 5, the processor 12 may be configured to compute the estimated softmax function 34 at least in part by executing a softmax estimation machine learning algorithm 36. The softmax estimation machine learning algorithm 36 may be a deep neural network. In one example, the softmax estimation machine learning algorithm 36 is a three-layer linear neural network. The softmax estimation machine learning algorithm 36 may be configured to receive, as input, a softmax estimation input 38 that may be computed by performing additional computation on the homomorphically encrypted ReLU output vector 48A received from the client computing device 110. In one example, the processor 12 may be configured to compute the estimated softmax function 34 according to the following equation:

$$S ( {x}_{i} ) = {x}_{i} * T ( {\sum }_{j} ReLU ( {( \frac{{x}_{j}}{2} + 1 )}^{3} ) )$$

The above equation is expressed in elementwise form in which xᵢ are elements of an input vector and T is the softmax estimation machine learning algorithm 36. In the above equation, the softmax estimation input 38 is the sum of the elements of the homomorphically encrypted ReLU output vector 48A.

Returning to FIG. 3, subsequently to computing the multi-head attention vector 98, the processor 12 may be further configured to add the multi-head attention vector 98 to the positional encoding 26 of the homomorphically encrypted input embedding vector 24 and normalize the result to obtain a normalized sum 54A. Thus, the processor 12 may be configured to incorporate information regarding the positions of tokens within the homomorphically encrypted input embedding vector 24 into the multi-head attention vector 98. As discussed in further detail below, the normalized sum 54A may be used as an input to an encoder feed-forward network 56. An additional normalized sum 54B may be computed from the normalized sum 54A and the output of the encoder feed-forward network 56, and the normalized sum 54B may be used as an input to the decoder layer 70.

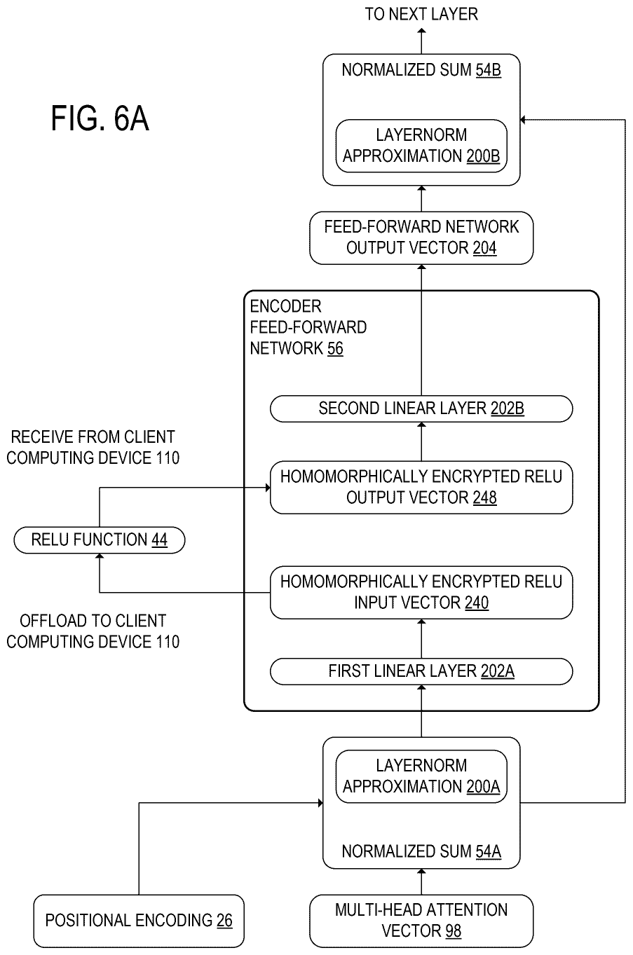

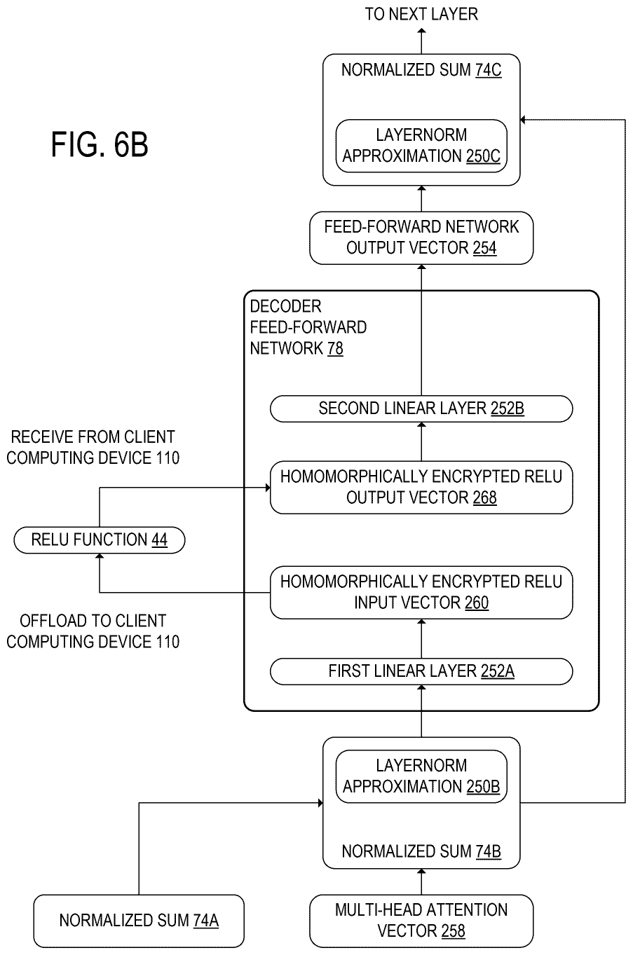

FIG. 6A schematically shows portions of the encoder layer 50 following the encoder multi-head attention 52 in additional detail, according to one example. Performing inferencing on the homomorphically encrypted intermediate input vectors 48 may include computing a plurality of layernorm approximations. As shown in FIG. 6A, when the normalized sum 54A is computed, the processor 12 may be further configured to compute a layernorm approximation 210A to normalize the sum of the positional encoding 26 and the multi-head attention vector 98. The layernorm approximation 210A may replace a layernorm function that is not supported by the homomorphic encryption technique used at the homomorphic encryption module 130. According to one example, the processor 12 may be configured to compute each of the layernorm approximations elementwise as

$$\hat{y} = x ∘ γ + β$$

where x is an input matrix element, ∘ is a Hadamard product, and γ and β are learned affine transform parameters. The values of γ and β may be learned during the training phase of the transformer network 30, as discussed in further detail below.

The normalized sum 54A may be a feed-forward network input vector which the processor 12 is configured to input into the encoder feed-forward network 56. In the example of FIG. 6A, the encoder feed-forward network 56 has a first linear layer 202A and a second linear layer 202B. At the first linear layer 202A, the processor 12 may be configured to compute a homomorphically encrypted ReLU input vector 240. The processor 12 may be further configured to offload the homomorphically encrypted ReLU input vector 240 to the client computing device 110, at which the client device processor 112 may be configured to compute a ReLU function 44 and transmit a homomorphically encrypted ReLU output vector 248 to the server computing device 10. The homomorphically encrypted ReLU output vector 248 may be computed at the client device processor 112 as discussed above with reference to FIG. 1. Thus, the ReLU function 44 may be used as an activation function of the encoder feed-forward network 56.

The processor 12 may be further configured to input the homomorphically encrypted ReLU output vector 248 into the second linear layer 202B, at which the processor 12 may be further configured to compute a feed-forward network output vector 204. Subsequently to computing the feed-forward network output vector 204, the processor 12 may be further configured to compute another normalized sum 54B of the feed-forward network output vector 204 and the normalized sum 54A. When the normalized sum 54B is computed, the processor 12 may be configured to compute another layernorm approximation 200B. The normalized sum 54B may be a feed-forward network output vector which the processor 12 is configured to output an additional computing process included in the transformer network 30.

Although FIG. 6A shows the encoder feed-forward network 56 with two linear layers, the encoder feed-forward network 56 may include three or more linear layers in some examples. In such examples, the processor 12 may be configured to offload computation of the ReLU function to the client computing device 110 when computing the activations between each pair of adjacent linear layers.

Returning to FIG. 3, for each encoder layer 50 prior to a final encoder layer 50 of the plurality of encoder layers 50, the normalized sum 54B may be output to a next encoder layer of the plurality of encoder layers 50. The normalized sum 54B computed at the last encoder layer 50 of the plurality of encoder layers 50 may instead be output to each of the plurality of decoder layers 70.

The processor 12 may be further configured to input a homomorphically encrypted output embedding vector 64 into a first decoder layer 70 of the plurality of decoder layers 70. The processor 12 may be configured to compute the homomorphically encrypted output embedding vector 64 via auto-regression for each output token included in the homomorphically encrypted output vector 60, such that when each output token following a first output token is computed, the homomorphically encrypted output vector 60 generated for a prior output token is used as the homomorphically encrypted output embedding vector 64. The token positions in the homomorphically encrypted output embedding vector 64 may be offset by one token toward the end of the homomorphically encrypted output embedding vector 64. The processor 12 may be further configured to compute a positional encoding 66 of the homomorphically encrypted output embedding vector 64.

Based at least in part on the homomorphically encrypted output embedding vector 64, the processor 12 may be further configured to perform masked multi-head attention 72 at each decoder layer 70. The masked multi-head attention 72 may be performed to avoid having earlier tokens included in the homomorphically encrypted output vector 60 depend upon later tokens. The masked multi-head attention 72 differs from the encoder multi-head attention 52 performed at the encoder layers 50 in that when the processor 12 performs the masked multi-head attention 72, the processor 12 may be further configured to replace values of the scaled dot-product attention matrix QK^{T}/\sqrt{dₖ} above the main diagonal with negative values. This replacement may allow softmax (QK^{T}/\sqrt{dₖ}) to be estimated as a value approximately equal to zero when the estimated softmax function 34 is computed. In some examples, the values of the scaled dot-product attention matrix above the main diagonal may be replaced by values between −2 and −5. Masking values within this range may allow the processor 12 to accurately compute the estimated softmax function 34 while also providing sufficient masking to avoid dependencies of earlier output tokens on later output tokens. The structure of the masked multi-head attention 72 may match the structure of the encoder multi-head attention 52 but with the masking step discussed above.

At each decoder layer 70, the processor 12 may be further configured to compute a normalized sum 74A of the positional encodings 66 and the output of the masked multi-head attention 72. The processor 12 may be further configured to perform decoder multi-head attention 76 on the normalized sum 74A. The decoder multi-head attention 76 may receive the normalized sum 54A of the final encoder layer 50 as the key vector K and the value vector V, and may further receive the normalized sum 74A as the query vector Q. Thus, the outputs of the final encoder layer 50 may be utilized at each of the decoder layers 70 when performing the decoder multi-head attention 76. The structure of the decoder multi-head attention 76 may match the structure of the encoder multi-head attention 52.

FIG. 6B schematically shows portions of a decoder layer 70 following the decoder multi-head attention 76 in additional detail, according to one example. Subsequently to performing the decoder multi-head attention 76, the processor 12 may be further configured to compute a normalized sum 74B of the normalized sum 74A and a multi-head attention vector 258 output by the decoder multi-head attention 76. When the processor 12 computes the normalized sum 74B, the processor 12 may be configured to compute a layernorm approximation 250B.

The normalized sum 74B may be used as a feed-forward network input vector which the processor 12 is configured to into a decoder feed-forward network 78. As shown in the example of FIG. 6B, the decoder feed-forward network 78 may include a first linear layer 252A and a second linear layer 252B. Between the first linear layer 252A and the second linear layer 252B, the processor 12 may be configured to compute a corresponding activation at least in part by offloading computation of the ReLU function 44 to the client computing device 110. When the processor 12 offloads the computation of the ReLU 44, the processor 12 may be configured to compute a homomorphically encrypted ReLU input vector 260 at least in part at the first linear layer 252A. The processor 12 may be further configured to transmit the homomorphically encrypted ReLU input vector 260 to the client computing device 110 and subsequently receive a homomorphically encrypted ReLU output vector 268 from the client computing device 110. The processor 12 may be further configured to input the homomorphically encrypted ReLU output vector 268 into the second linear layer 252B to compute a feed-forward network output vector 254.

Subsequently to computing the feed-forward network output vector 254, the processor 12 may be further configured to compute a normalized sum 74C of the feed-forward network output vector 254 and the normalized sum 74B. The processor 12 may be configured to compute a layernorm approximation 250C when computing the normalized sum 74C. The normalized sum 74C may be the output of that decoder layer 70 and may be output to an additional computing process included in the transformer network 30.

Similarly to the encoder feed-forward network 56, the decoder feed-forward network 78 may include three or more linear layers in some examples. In such examples, the processor 12 may be configured to offload computation of the ReLU function 44 to the client computing device 110 between each pair of adjacent linear layers.

Returning to FIG. 3, the transformer network 30 may further include a final linear layer 80 subsequently to a final decoder layer 70 of the plurality of decoder layers 70. The final linear layer 80 may be configured to receive the normalized sum 74C from the final decoder layer 70 as input. In addition, the processor 12 may be further configured to compute a final linear layer output 82 at the final linear layer 80 based at least in part on the decoder layer output. The processor 12 may be further configured to compute an estimated softmax function 34 on the final linear layer output 82 of the final linear layer 80 to compute the homomorphically encrypted output vector 60. The processor 12 may be further configured to transmit the homomorphically encrypted output vector 60 to the client computing device 110, as discussed above.

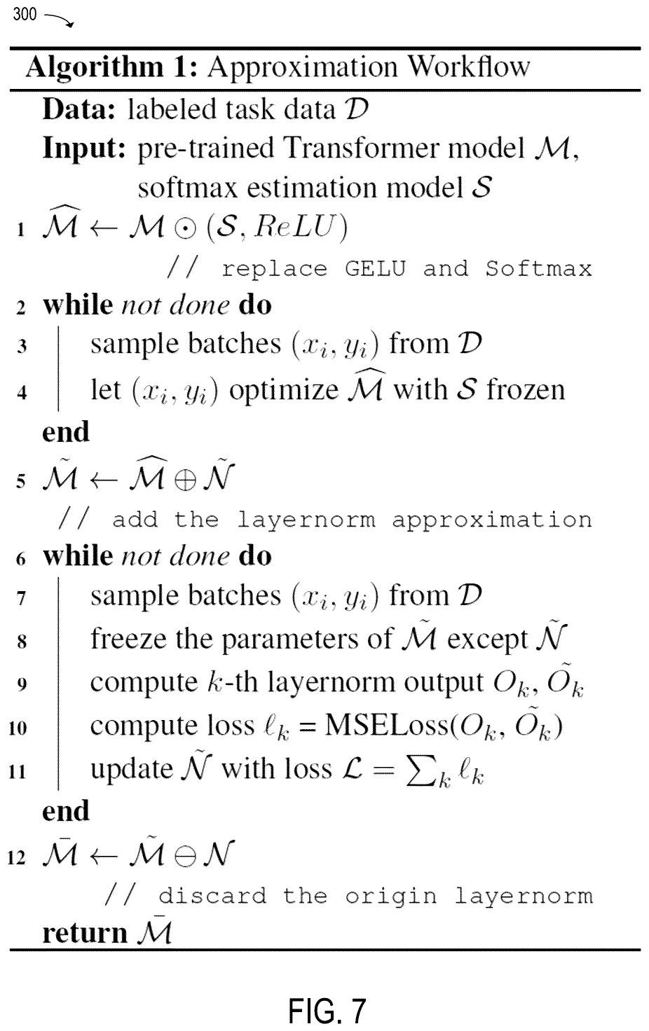

FIG. 7 shows pseudocode of a transformer training algorithm 300 that may be performed when training the transformer network 30, according to some examples. In the example of FIG. 7, a pre-trained transformer network M is modified to be used with homomorphically encrypted inputs. The pre-trained transformer network M was previously trained with plaintext training data. As shown in FIG. 7, the inputs of the transformer training algorithm 300 may further include labeled task data D and a softmax estimation model S. The softmax estimation model S may be the estimated softmax function 34 after the softmax estimation machine learning algorithm 36 has been trained.

When performing the transformer training algorithm 300 of FIG. 7, the processor 12 may be configured to replace the softmax function in the pre-trained transformer network M with the softmax estimation model S. The processor 12 may be further configured to replace a Gaussian error linear unit (GeLU) function in the pre-trained transformer network M with a ReLU function 44. Thus, the processor 12 may be configured to generate a first modified transformer network \hat{M}. Subsequently to performing these replacements, the processor 12 may be further configured to perform gradient descent at the first modified transformer network \hat{M} with the parameters of the softmax estimation model S held constant. Gradient descent may be performed at the modified transformer network M using batches of task data elements (xᵢ, yᵢ) sampled from the labeled task data D.

Subsequently to performing gradient descent to train the first modified transformer network \hat{M}, the processor 12 may be further configured to replace the layernorm function in the first modified transformer network \hat{M} with a layernorm approximation function Ñ to obtain a second modified transformer network \tilde{M}. The layernorm approximation function Ñ may be configured to be computed elementwise as discussed above. The processor 12 may be further configured to sample additional batches of task data elements (xᵢ, yᵢ) from the task data D and train the layernorm approximation function Ñ using the additional batches. When training the layernorm approximation function Ñ, the processor 12 may be configured to compute values of a mean squared error loss function L between the outputs of the layernorm approximation function Ñ and an exact layernorm function N. The processor 12 may be further configured to perform gradient descent using a gradient of the mean squared error loss function L with respect to the learnable affine transform parameters of the layernorm approximation function Ñ. The processor 12 may be further configured to discard the exact layernorm function N to obtain a trained transformer network M̅. The trained transformer network M̅ may be used as the transformer network 30 during inferencing.

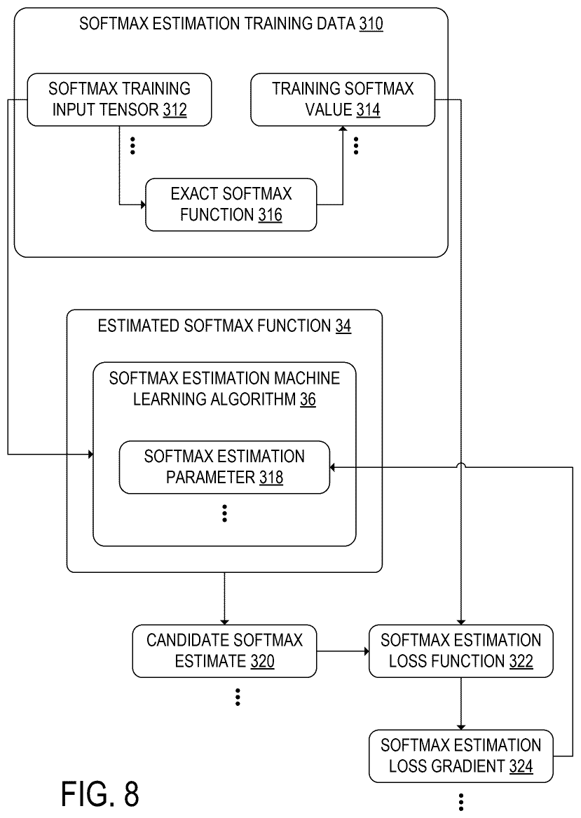

As discussed above, the softmax estimation machine learning algorithm 36 may be trained separately from other components of the transformer network 30. FIG. 8 schematically shows the softmax estimation machine learning algorithm 36 during training. The softmax estimation machine learning algorithm 36 may be trained using softmax estimation training data 310 that includes a plurality of softmax training input tensors 312. The softmax training input tensors 312 may be randomly or pseudorandomly generate tensors with elements that are each within a predefined range. In one example, the elements of the softmax training input tensors 312 may be between −3 and 3. The processor 12 may be further configured to compute a plurality of training softmax values 314 by applying an exact softmax function 316 to the plurality of softmax training input tensors 312.

The processor 12 may be further configured to input the plurality of softmax training input tensors 312 into the softmax estimation machine learning algorithm 36. At least in part at the softmax estimation machine learning algorithm 36, the processor 12 may be further configured to compute a respective plurality of candidate softmax estimates 320 for the plurality of softmax training input tensors 312. In some examples, the processor 12 may be configured to perform additional processing on the output of the softmax estimation machine learning algorithm 36 to generate the candidate softmax estimates 320 with the estimated softmax function, as discussed above with reference to FIG. 5.

The processor 12 may be further configured to compute values of a softmax estimation loss function 322 at least in part by comparing the training softmax values 314 generated with the exact softmax function 316 to the plurality of candidate softmax estimates 320. For example, the softmax estimation loss function 322 may be a mean squared error loss function. The processor 12 may be further configured to compute values of a softmax estimation loss gradient 324 of the softmax estimation loss function 322 with respect to softmax estimation parameters 318 of the softmax estimation machine learning algorithm 36. The processor 12 may be further configured to perform gradient descent using the values of the softmax estimation loss gradient 324 to update the values of the softmax estimation parameters 318. Thus, the processor 12 may be configured to train the softmax estimation machine learning algorithm 36 included in the estimated softmax function 34.

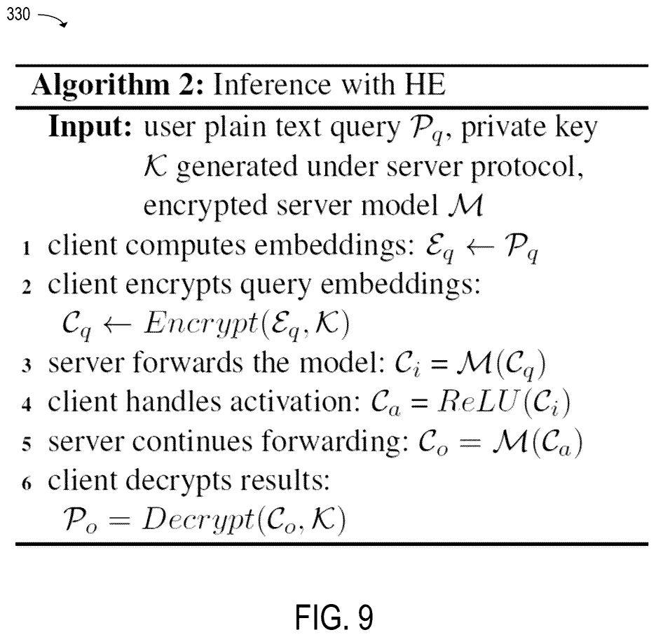

FIG. 9 shows pseudocode of a transformer runtime algorithm 330, according to one example. The inputs to the transformer runtime algorithm 330, as shown in FIG. 9, include the plaintext query 20 and the private key 22, which are input at the client computing device 110. The inputs to the transformer runtime algorithm 330 further include the transformer network 30 stored at the server computing device 10.

The client device processor 112 may be configured to compute the input embedding vector 21 based at least in part on the plaintext query 20. The client device processor 112 may be further configured to compute a homomorphically encrypted input embedding vector 24 from the input embedding vector 21 and the private key 22. Subsequently to computing the homomorphically encrypted input embedding vector 24, the client device processor 112 may be further configured to transmit the homomorphically encrypted input embedding vector 24 to the server computing device 10.

At the server computing device 10, the processor 12 may perform inferencing on the homomorphically encrypted input embedding vector 24. The ReLU function 44 that occurs during inferencing may be performed at the client device processor 112 instead of the processor 12 of the server computing device 10. After the ReLU function 44 has been computed at the client device processor 112, the processor 12 included in the server computing device 10 may be further configured to continue performing inferencing at the transformer network 30. Subsequently to generating a homomorphically encrypted output vector 60 as a final result of the inferencing, the homomorphically encrypted output vector 60 may be decrypted at the client device processor 112 to obtain a plaintext output 62.

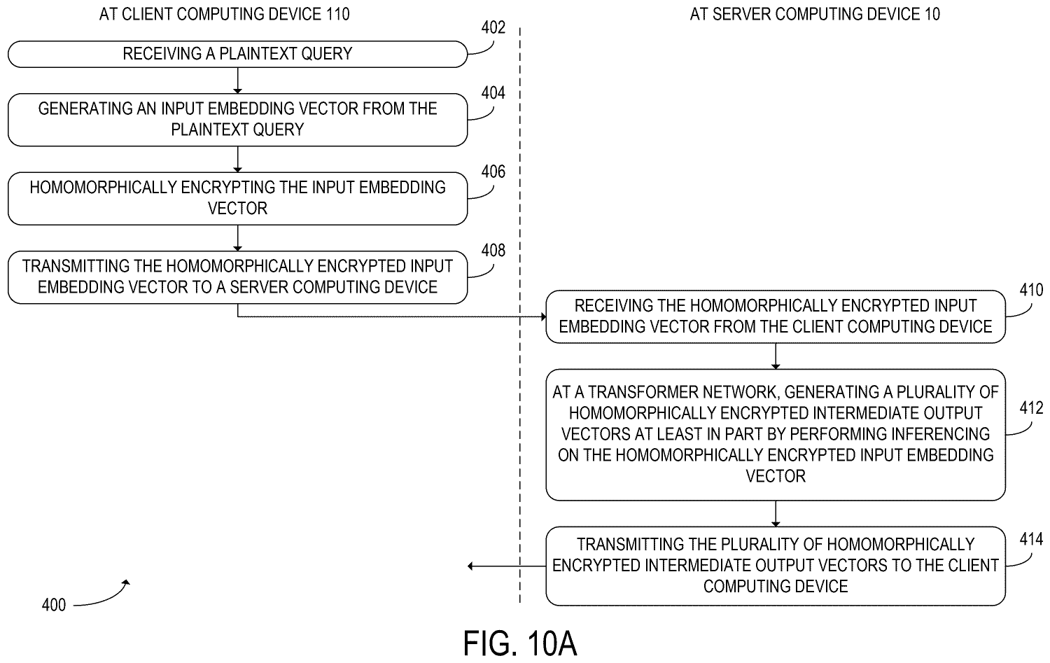

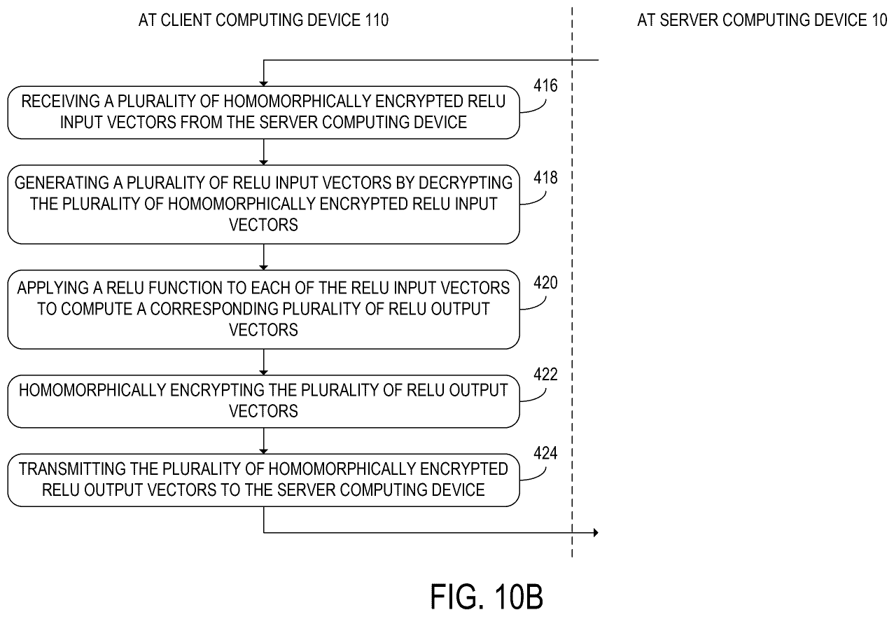

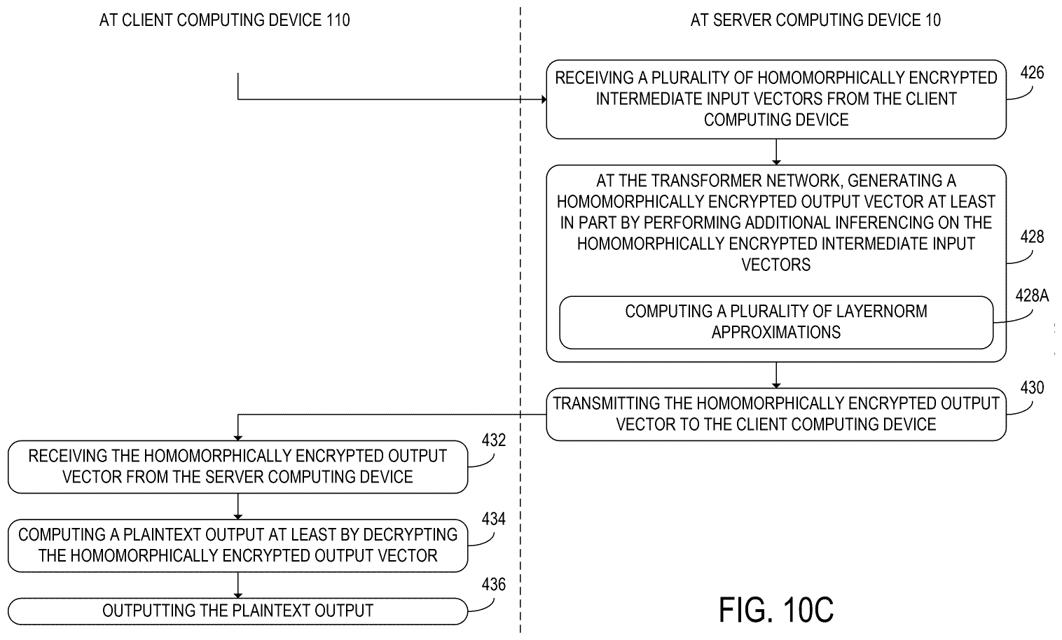

FIGS. 10A-10C show a flowchart of a method 400 by which homomorphically encrypted inferencing may be performed at a transformer network. The method 400 of FIGS. 10A-10C may be performed at the client computing device 110 and the server computing device 10 of FIG. 1. At step 402, as shown in FIG. 10A, the method 400 may include receiving a plaintext query 402 at the client computing device. For example, the plaintext query may be received via user input at a GUI. Additionally or alternatively, at least a portion of the plaintext query may be programmatically generated at the client computing device. The method 400 may further include, at step 404, generating an input embedding vector from the plaintext query received in step 402. At step 406, the method 400 may further include homomorphically encrypting the input embedding vector. The input embedding vector may be homomorphically encrypted using a CKKS algorithm, a GSW algorithm, a FHEW algorithm, a TFHE algorithm, a BGV algorithm, a BFV algorithm, or some other homomorphic encryption algorithm. At step 408, the method 400 may further include transmitting the homomorphically encrypted input embedding vector to the server computing device.

At step 410, the method 400 may further include, at the server computing device, receiving the homomorphically encrypted input embedding vector from the client computing device. At step 412, the method 400 may further include generating a plurality of homomorphically encrypted intermediate output vectors at a transformer network. The plurality of homomorphically encrypted intermediate output vectors may be generated at least in part by performing inferencing on the homomorphically encrypted input embedding vector. At step 414, the method 400 may further include transmitting the plurality of homomorphically encrypted intermediate output vectors to the client computing device. The plurality of homomorphically encrypted intermediate output vectors may be transmitted to the client computing device in order for the client computing device to perform operations on the homomorphically encrypted intermediate output vectors other than addition or multiplication.

FIG. 10B shows further steps of the method 400, according to one example. In the example of FIG. 10B, the plurality of homomorphically encrypted intermediate output vectors are homomorphically encrypted ReLU input vectors. At step 416, the method 400 may further include, at the client computing device, receiving the plurality of homomorphically encrypted ReLU input vectors from the server computing device. At step 418, the method 400 may further include generating a plurality of ReLU input vectors by decrypting the plurality of homomorphically encrypted ReLU input vectors. At step 420, the method 400 may further include applying a ReLU function to each of the ReLU input vectors to compute a corresponding plurality of ReLU output vectors. The method 400 may further include, at step 422, homomorphically encrypting the plurality of ReLU output vectors to compute a respective plurality of homomorphically encrypted ReLU output vectors. At step 424, the method 400 may further include transmitting the plurality of homomorphically encrypted ReLU output vectors to the server computing device. Thus, computation of the ReLU function may be offloaded to the client computing device.

FIG. 10C shows additional steps of the method 400, according to one example. At step 426, the method 400 may further include, at the server computing device, receiving a plurality of homomorphically encrypted intermediate input vectors from the client computing device. The homomorphically encrypted intermediate input vectors may be received subsequently to transmitting the homomorphically encrypted intermediate output vectors to the client computing device, and may be homomorphically encrypted ReLU output vectors, as shown in FIG. 10B. At step 428, the method 400 may further include generating a homomorphically encrypted output vector at the transformer network. The homomorphically encrypted output vector may be generated at least in part by performing additional inferencing on the homomorphically encrypted intermediate input vectors.

In some examples, at step 428A, performing inferencing on the homomorphically encrypted intermediate input vectors may include computing a plurality of layernorm approximations. The layernorm approximations may approximate a layernorm function using only addition and multiplication operations. For example, each of the layernorm approximations may be computed elementwise as

$$\hat{y} = x ∘ γ + β$$

where x is an input matrix element, ∘ is a Hadamard product, and γ and β are learned affine transform parameters.

At step 430, subsequently to generating the homomorphically encrypted output vector, the method 400 may further include transmitting the homomorphically encrypted output vector to the client computing device.

At the client computing device, the method 400 may further include, at step 432, receiving the homomorphically encrypted output vector from the server computing device. At step 434, the method 400 may further include computing a plaintext output at least by decrypting the homomorphically encrypted output vector. At step 436, the method 400 may further include outputting the plaintext output.

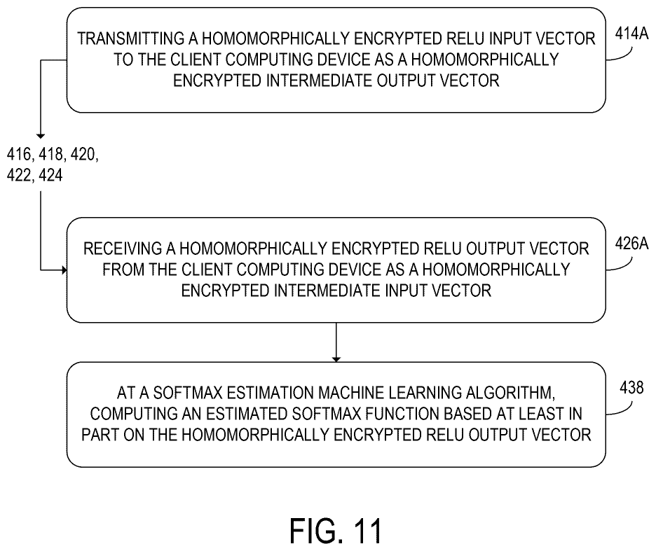

FIG. 11 shows additional steps of the method 400 that may be performed in some examples when computing an estimated softmax function. For example, the softmax function may be computed at each of a plurality of attention heads of the transformer network. The estimated softmax function may also be computed to homomorphically encrypted output vector at the end of inferencing. At step 414A, the method 400 may include transmitting a homomorphically encrypted ReLU input vector to the client computing device as a homomorphically encrypted intermediate output vector. The homomorphically encrypted ReLU input vector may be received at the client computing device, processed, and output to the server computing device according to steps 416, 418, 420, 422, and 424, as shown in FIG. 10B. At step 426A, the method 400 may further include, at the server computing device, receiving a homomorphically encrypted ReLU output vector from the client computing device as a homomorphically encrypted intermediate input vector subsequently to transmitting the homomorphically encrypted ReLU input vector to the client computing device.

At step 438, the method 400 may further include computing the estimated softmax function at least in part by executing a softmax estimation machine learning algorithm. The estimated softmax function may be computed at the softmax estimation machine learning algorithm based at least in part on the homomorphically encrypted ReLU output vector. In some examples, the softmax estimation machine learning algorithm may be a machine learning model that has a plurality of linear layers. The softmax estimation machine learning algorithm may be configured to utilize only addition and multiplication operations such that the softmax estimation machine learning algorithm may be applied to homomorphically encrypted data without having to offload operations on the homomorphically encrypted data to the client computing device. In some examples, computing the estimated softmax function may further include performing one or more further computations on the output of the softmax estimation machine learning algorithm.

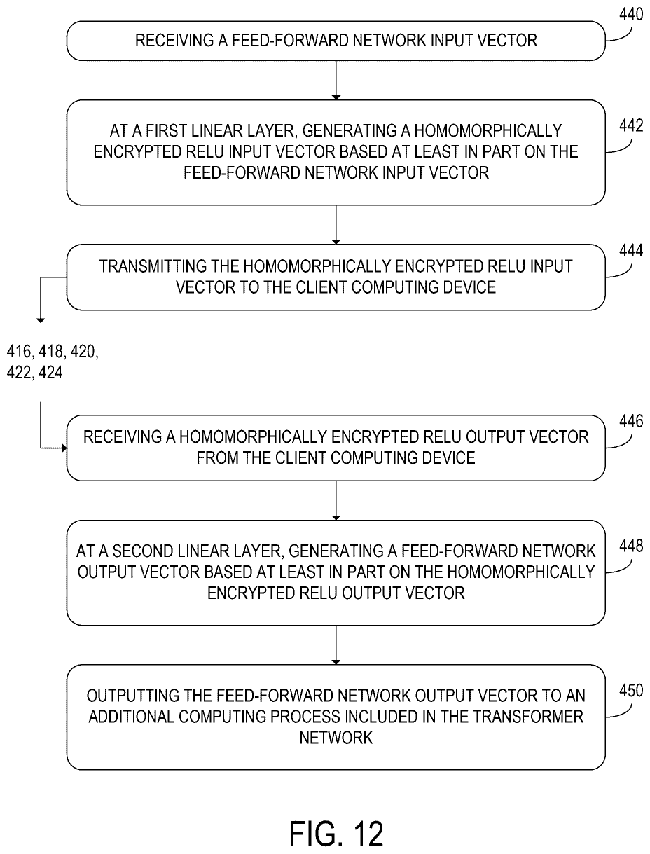

FIG. 12 shows additional steps of the method 400 that may be performed at each of a plurality of feed-forward networks included in the transformer network when performing inferencing on the homomorphically encrypted input embedding vector. The steps of FIG. 12 may be performed at each of a plurality of encoder networks and each of a plurality of decoder networks included in the transformer network. At step 440, the method 400 may include receiving a feed-forward network input vector. The feed-forward network input vector may be a normalized sum of a multi-head attention vector and a positional encoding vector. Alternatively, the feed-forward network input vector may be a normalized sum of a multi-head attention vector and another normalized sum. The other normalized sum, in such examples, may be a normalized sum of a positional encoding vector and a masked multi-head attention vector.

At step 442, the method 400 may further include generating a homomorphically encrypted ReLU input vector at a first linear layer of the feed-forward network based at least in part on the feed-forward network input vector. Generating the homomorphically encrypted ReLU input vector may include only addition and multiplication operations and may accordingly be computed at the server computing device without having to offload computations to the client computing device.

At step 444, the method 400 may further include transmitting the homomorphically encrypted ReLU input vector to the client computing device. At step 446, subsequently to transmitting the homomorphically encrypted ReLU input vector to the client computing device, the method 400 may further include receiving a homomorphically encrypted ReLU output vector from the client computing device. The homomorphically encrypted ReLU output vector may be computed by performing steps 416, 418, 420, 422, and 424 at the client computing device. Thus, a ReLU function included in an activation function of the feed-forward network may be offloaded to the client computing device.

At step 448, the method 400 may further include generating a feed-forward network output vector at a second linear layer based at least in part on the homomorphically encrypted ReLU output vector. At step 450, the method 400 may further include outputting the feed-forward network output vector to an additional computing process included in the transformer network. The additional computing process may, for example, be a computation of a normalized sum of the feed-forward network output vector and another vector.

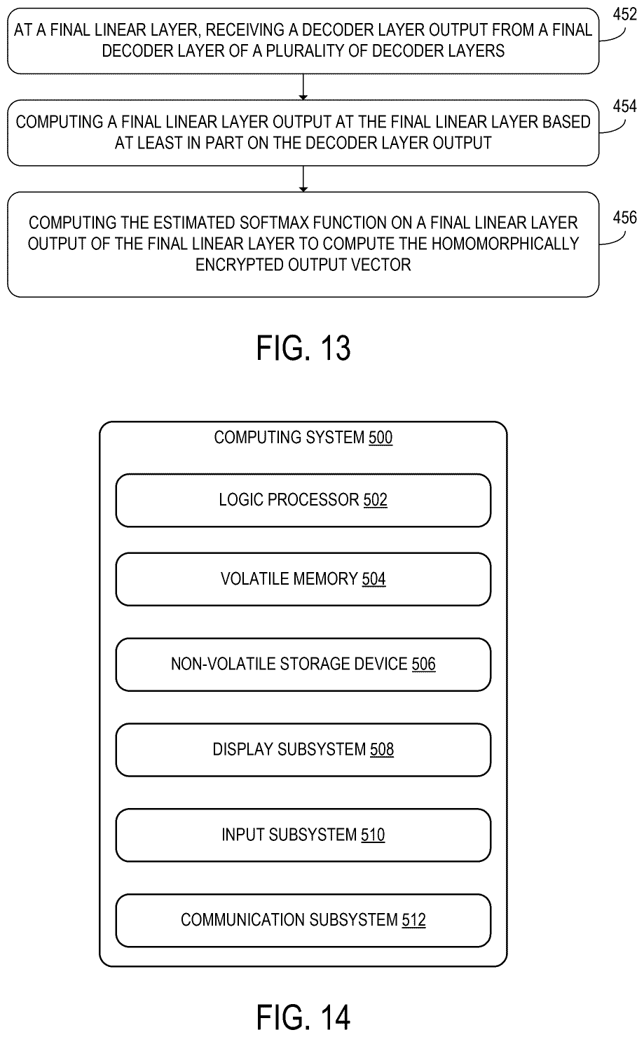

FIG. 13 shows additional steps of the method 400 that may be performed subsequently to performing inferencing at the plurality of decoder layers of the transformer network. At step 452, the method 400 may further include, at a final linear layer, receiving a decoder layer output from a final decoder layer of the plurality of decoder layers. At step 454, the method 400 may further include computing a final linear layer output at the final linear layer based at least in part on the decoder layer output. The method 400 may further include, at step 456, computing the estimated softmax function of the final layer output of the final linear layer to compute the homomorphically encrypted output vector.

Using the devices and methods discussed above, inferencing may be performed at a transformer network on homomorphically encrypted data. During this inferencing, the homomorphically encrypted data may remain encrypted during each operation performed at the server computing device where the transformer network is stored. Operations not supported by the technique used to homomorphically encrypt the input may be offloaded to the client computing device from which the input was received. The devices and methods discussed above may protect the privacy of user data during inferencing at the transformer network. Accordingly, the devices and methods discussed above may allow transformer networks to be used for a wider variety of tasks in which sensitive user inputs are processed.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 14 schematically shows a non-limiting embodiment of a computing system 500 that can enact one or more of the methods and processes described above. Computing system 500 is shown in simplified form. Computing system 500 may embody the server computing device 10 and/or the client computing device 110 described above and illustrated in FIG. 1. Components of the computing system 500 may be included in one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 500 includes a logic processor 502 volatile memory 504, and a non-volatile storage device 506. Computing system 500 may optionally include a display subsystem 508, input subsystem 510, communication subsystem 512, and/or other components not shown in FIG. 14.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Non-volatile storage device 506 includes one or more physical devices configured to hold instructions executable by the logic processors to implement the methods and processes described herein. When such methods and processes are implemented, the state of non-volatile storage device 506 may be transformed e.g., to hold different data.

Non-volatile storage device 506 may include physical devices that are removable and/or built-in. Non-volatile storage device 506 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 500 to send and/or receive messages to and/or from other devices via a network such as the Internet.

The following paragraphs discuss several aspects of the present disclosure. According to one aspect of the present disclosure, a server computing device is provided, including a processor configured to receive a homomorphically encrypted input embedding vector from a client computing device. At a transformer network, the processor may be further configured to generate a plurality of homomorphically encrypted intermediate output vectors at least in part by performing inferencing on the homomorphically encrypted input embedding vector. The processor may be further configured to transmit the plurality of homomorphically encrypted intermediate output vectors to the client computing device. The processor may be further configured to receive a plurality of homomorphically encrypted intermediate input vectors from the client computing device subsequently to transmitting the homomorphically encrypted intermediate output vectors to the client computing device. At the transformer network, the processor may be further configured to generate a homomorphically encrypted output vector at least in part by performing additional inferencing on the homomorphically encrypted intermediate input vectors. The processor may be further configured to transmit the homomorphically encrypted output vector to the client computing device.

According to this aspect, the plurality of homomorphically encrypted intermediate input vectors may include a plurality of homomorphically encrypted rectified linear unit (ReLU) output vectors.

According to this aspect, when performing inferencing on the homomorphically encrypted input embedding vector, the processor may be configured to compute an estimated softmax function at least in part by executing a softmax estimation machine learning algorithm.

According to this aspect, when computing the estimated softmax function, the processor may be further configured to transmit a homomorphically encrypted ReLU input vector to the client computing device as a homomorphically encrypted intermediate output vector. The processor may be further configured to receive a homomorphically encrypted ReLU output vector from the client computing device as a homomorphically encrypted intermediate input vector subsequently to transmitting the homomorphically encrypted ReLU input vector to the client computing device. At the softmax estimation machine learning algorithm, the processor may be further configured to compute the estimated softmax function based at least in part on the homomorphically encrypted ReLU output vector.

According to this aspect, the transformer network may include a plurality of encoder layers and a plurality of decoder layers. The plurality of encoder layers and the plurality of encoder layers may each include a respective plurality of attention heads. The processor may be configured to compute the estimated softmax function at each of the plurality of attention heads.

According to this aspect, at a final linear layer, the processor may be further configured to receive a decoder layer output from a final decoder layer of the plurality of decoder layers. The processor may be configured to compute a final linear layer output at the final linear layer based at least in part on the decoder layer output. The processor may be configured to compute the estimated softmax function on the final linear layer output of the final linear layer to compute the homomorphically encrypted output vector.

According to this aspect, performing inferencing on the homomorphically encrypted input embedding vector may include, at each of a plurality of feed-forward networks included in the transformer network, receiving a feed-forward network input vector. At a first linear layer, performing inferencing may further include generating a homomorphically encrypted ReLU input vector based at least in part on the feed-forward network input vector. Performing inferencing may further include transmitting the homomorphically encrypted ReLU input vector to the client computing device. Subsequently to transmitting the homomorphically encrypted ReLU input vector to the client computing device, performing inferencing may further include receiving a homomorphically encrypted ReLU output vector from the client computing device. At a second linear layer, performing inferencing may further include generating a feed-forward network output vector based at least in part on the homomorphically encrypted ReLU output vector. Performing inferencing may further include outputting the feed-forward network output vector to an additional computing process included in the transformer network.

According to this aspect, performing inferencing on the homomorphically encrypted intermediate input vectors may include computing a plurality of layernorm approximations.

According to this aspect, the processor may be configured to compute each of the layernorm approximations elementwise as

$$\hat{y} = x ∘ γ + β$$

where x is an input matrix element, ∘ is a Hadamard product, and γ and β are learned affine transform parameters.

According to this aspect, the transformer network may include a convolution layer downstream of a plurality of attention heads.

According to this aspect, at each of a plurality of attention heads included in the transformer network, the processor may be configured to perform attention score scaling at a respective query projection layer.

According to this aspect, each computation performed on the homomorphically encrypted input embedding vector and the homomorphically encrypted intermediate input vectors during inferencing at the transformer network may be an addition or multiplication operation.

According to another aspect of the present disclosure, a method for use with a server computing device is provided. The method may include receiving a homomorphically encrypted input embedding vector from a client computing device.

The method may further include, at a transformer network, generating a plurality of homomorphically encrypted intermediate output vectors at least in part by performing inferencing on the homomorphically encrypted input embedding vector. The method may further include transmitting the plurality of homomorphically encrypted intermediate output vectors to the client computing device. The method may further include receiving a plurality of homomorphically encrypted intermediate input vectors from the client computing device subsequently to transmitting the homomorphically encrypted intermediate output vectors to the client computing device. The method may further include, at the transformer network, generating a homomorphically encrypted output vector at least in part by performing additional inferencing on the homomorphically encrypted intermediate input vectors. The method may further include transmitting the homomorphically encrypted output vector to the client computing device.

According to this aspect, the plurality of homomorphically encrypted intermediate input vectors may include a plurality of homomorphically encrypted rectified linear unit (ReLU) output vectors.

According to this aspect, when performing inferencing on the homomorphically encrypted input embedding vector, the method may further include computing an estimated softmax function at least in part by executing a softmax estimation machine learning algorithm.

According to this aspect, the method may further include, when computing the estimated softmax function, transmitting a homomorphically encrypted ReLU input vector to the client computing device as a homomorphically encrypted intermediate output vector. The method may further include receiving a homomorphically encrypted ReLU output vector from the client computing device as a homomorphically encrypted intermediate input vector subsequently to transmitting the homomorphically encrypted ReLU input vector to the client computing device. The method may further include, at the softmax estimation machine learning algorithm, computing the estimated softmax function based at least in part on the homomorphically encrypted ReLU output vector.

According to this aspect, the transformer network may include a plurality of encoder layers and a plurality of decoder layers. The plurality of encoder layers and the plurality of encoder layers may each include a respective plurality of attention heads. The estimated softmax function may be computed at each of the plurality of attention heads.

According to this aspect, performing inferencing on the homomorphically encrypted input embedding vector may include, at each of a plurality of feed-forward networks included in the transformer network, receiving a feed-forward network input vector. At a first linear layer, performing inferencing may further include generating a homomorphically encrypted ReLU input vector based at least in part on the feed-forward network input vector. Performing inferencing may further include transmitting the homomorphically encrypted ReLU input vector to the client computing device. Subsequently to transmitting the homomorphically encrypted ReLU input vector to the client computing device, performing inferencing may further include receiving a homomorphically encrypted ReLU output vector from the client computing device. At a second linear layer, performing inferencing may further include generating a feed-forward network output vector based at least in part on the homomorphically encrypted ReLU output vector. Performing inferencing may further include outputting the feed-forward network output vector to an additional computing process included in the transformer network.

According to this aspect, performing inferencing on the homomorphically encrypted intermediate input vectors may include computing a plurality of layernorm approximations.

According to another aspect of the present disclosure, a client computing device is provided, including a client device processor configured to receive a plaintext query. The client device processor may be further configured to generate an input embedding vector from the plaintext query. The client device processor may be further configured to homomorphically encrypt the input embedding vector. The client device processor may be further configured to transmit the homomorphically encrypted input embedding vector to a server computing device. Subsequently to transmitting the homomorphically encrypted input embedding vector to the server computing device, the client device processor may be further configured to receive a plurality of homomorphically encrypted rectified linear unit (ReLU) input vectors from the server computing device. The client device processor may be further configured to generate a plurality of ReLU input vectors by decrypting the plurality of homomorphically encrypted ReLU input vectors. The client device processor may be further configured to apply a ReLU function to each of the ReLU input vectors to compute a corresponding plurality of ReLU output vectors. The client device processor may be further configured to homomorphically encrypt the plurality of ReLU output vectors. The client device processor may be further configured to transmit the plurality of homomorphically encrypted ReLU output vectors to the server computing device. Subsequently to transmitting the plurality of homomorphically encrypted ReLU output vectors to the server computing device, the client device processor may be further configured to receive a homomorphically encrypted output vector from the server computing device. The client device processor may be further configured to compute a plaintext output at least by decrypting the homomorphically encrypted output vector. The client device processor may be further configured to output the plaintext output.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A server computing device comprising:
a processor configured to:
receive a homomorphically encrypted input embedding vector from a client computing device;
at a transformer network, generate a plurality of homomorphically encrypted intermediate output vectors at least in part by performing inferencing on the homomorphically encrypted input embedding vector;
transmit the plurality of homomorphically encrypted intermediate output vectors to the client computing device;
receive a plurality of homomorphically encrypted intermediate input vectors from the client computing device subsequently to transmitting the homomorphically encrypted intermediate output vectors to the client computing device;
at the transformer network, generate a homomorphically encrypted output vector at least in part by performing additional inferencing on the homomorphically encrypted intermediate input vectors; and
transmit the homomorphically encrypted output vector to the client computing device.

2. The server computing device of claim 1, wherein the plurality of homomorphically encrypted intermediate input vectors include a plurality of homomorphically encrypted rectified linear unit (ReLU) output vectors.

3. The server computing device of claim 2, wherein, when performing inferencing on the homomorphically encrypted input embedding vector, the processor is configured to compute an estimated softmax function at least in part by executing a softmax estimation machine learning algorithm.

4. The server computing device of claim 3, wherein, when computing the estimated softmax function, the processor is further configured to:
transmit a homomorphically encrypted ReLU input vector to the client computing device as a homomorphically encrypted intermediate output vector;
receive a homomorphically encrypted ReLU output vector from the client computing device as a homomorphically encrypted intermediate input vector subsequently to transmitting the homomorphically encrypted ReLU input vector to the client computing device; and
at the softmax estimation machine learning algorithm, compute the estimated softmax function based at least in part on the homomorphically encrypted ReLU output vector.

5. The server computing device of claim 3, wherein:
the transformer network includes a plurality of encoder layers and a plurality of decoder layers;
the plurality of encoder layers and the plurality of encoder layers each include a respective plurality of attention heads; and
the processor is configured to compute the estimated softmax function at each of the plurality of attention heads.

6. The server computing device of claim 5, wherein the processor is further configured to:
at a final linear layer, receive a decoder layer output from a final decoder layer of the plurality of decoder layers;
compute a final linear layer output at the final linear layer based at least in part on the decoder layer output; and
compute the estimated softmax function on the final linear layer output of the final linear layer to compute the homomorphically encrypted output vector.

7. The server computing device of claim 2, wherein performing inferencing on the homomorphically encrypted input embedding vector includes, at each of a plurality of feed-forward networks included in the transformer network:
receiving a feed-forward network input vector;
at a first linear layer, generating a homomorphically encrypted ReLU input vector based at least in part on the feed-forward network input vector;
transmitting the homomorphically encrypted ReLU input vector to the client computing device;
subsequently to transmitting the homomorphically encrypted ReLU input vector to the client computing device, receiving a homomorphically encrypted ReLU output vector from the client computing device;
at a second linear layer, generating a feed-forward network output vector based at least in part on the homomorphically encrypted ReLU output vector; and
outputting the feed-forward network output vector to an additional computing process included in the transformer network.

8. The server computing device of claim 1, wherein performing inferencing on the homomorphically encrypted intermediate input vectors includes computing a plurality of layernorm approximations.

9. The server computing device of claim 8, wherein the processor is configured to compute each of the layernorm approximations elementwise as
$$\hat{y} = x ∘ γ + β$$
where x is an input matrix element, ∘ is a Hadamard product, and γ and β are learned affine transform parameters.

10. The server computing device of claim 1, wherein the transformer network includes a convolution layer downstream of a plurality of attention heads.

11. The server computing device of claim 1, wherein, at each of a plurality of attention heads included in the transformer network, the processor is configured to perform attention score scaling at a respective query projection layer.

12. The server computing device of claim 1, wherein each computation performed on the homomorphically encrypted input embedding vector and the homomorphically encrypted intermediate input vectors during inferencing at the transformer network is an addition or multiplication operation.

13. A method for use with a server computing device, the method comprising:
receiving a homomorphically encrypted input embedding vector from a client computing device;
at a transformer network, generating a plurality of homomorphically encrypted intermediate output vectors at least in part by performing inferencing on the homomorphically encrypted input embedding vector;
transmitting the plurality of homomorphically encrypted intermediate output vectors to the client computing device;
receiving a plurality of homomorphically encrypted intermediate input vectors from the client computing device subsequently to transmitting the homomorphically encrypted intermediate output vectors to the client computing device;
at the transformer network, generating a homomorphically encrypted output vector at least in part by performing additional inferencing on the homomorphically encrypted intermediate input vectors; and
transmitting the homomorphically encrypted output vector to the client computing device.

14. The method of claim 13, wherein the plurality of homomorphically encrypted intermediate input vectors include a plurality of homomorphically encrypted rectified linear unit (ReLU) output vectors.

15. The method of claim 13, further comprising, when performing inferencing on the homomorphically encrypted input embedding vector, computing an estimated softmax function at least in part by executing a softmax estimation machine learning algorithm.

16. The method of claim 15, further comprising, when computing the estimated softmax function:
transmitting a homomorphically encrypted ReLU input vector to the client computing device as a homomorphically encrypted intermediate output vector;
receiving a homomorphically encrypted ReLU output vector from the client computing device as a homomorphically encrypted intermediate input vector subsequently to transmitting the homomorphically encrypted ReLU input vector to the client computing device; and
at the softmax estimation machine learning algorithm, computing the estimated softmax function based at least in part on the homomorphically encrypted ReLU output vector.

17. The method of claim 15, wherein:
the transformer network includes a plurality of encoder layers and a plurality of decoder layers;
the plurality of encoder layers and the plurality of encoder layers each include a respective plurality of attention heads; and
the estimated softmax function is computed at each of the plurality of attention heads.

18. The method of claim 14, wherein performing inferencing on the homomorphically encrypted input embedding vector includes, at each of a plurality of feed-forward networks included in the transformer network:
receiving a feed-forward network input vector;
at a first linear layer, generating a homomorphically encrypted ReLU input vector based at least in part on the feed-forward network input vector;
transmitting the homomorphically encrypted ReLU input vector to the client computing device;
subsequently to transmitting the homomorphically encrypted ReLU input vector to the client computing device, receiving a homomorphically encrypted ReLU output vector from the client computing device;
at a second linear layer, generating a feed-forward network output vector based at least in part on the homomorphically encrypted ReLU output vector; and
outputting the feed-forward network output vector to an additional computing process included in the transformer network.

19. The method of claim 13, wherein performing inferencing on the homomorphically encrypted intermediate input vectors includes computing a plurality of layernorm approximations.

20. A client computing device comprising:
a client device processor configured to:
receive a plaintext query;
generate an input embedding vector from the plaintext query;
homomorphically encrypt the input embedding vector;
transmit the homomorphically encrypted input embedding vector to a server computing device;
subsequently to transmitting the homomorphically encrypted input embedding vector to the server computing device, receive a plurality of homomorphically encrypted rectified linear unit (ReLU) input vectors from the server computing device;
generate a plurality of ReLU input vectors by decrypting the plurality of homomorphically encrypted ReLU input vectors;
apply a ReLU function to each of the ReLU input vectors to compute a corresponding plurality of ReLU output vectors;
homomorphically encrypt the plurality of ReLU output vectors;
transmit the plurality of homomorphically encrypted ReLU output vectors to the server computing device;
subsequently to transmitting the plurality of homomorphically encrypted ReLU output vectors to the server computing device, receive a homomorphically encrypted output vector from the server computing device;
compute a plaintext output at least by decrypting the homomorphically encrypted output vector, and
output the plaintext output.
